(19) United States
(12) Patent Application Publication
(10) Pub. No.: US 2006/0021455 A1
(43) Pub. Date: Feb. 2, 2006

(54) Power takeoff assembly and method

(76) Inventor: John M. Seipold, Glasford, IL (US)

Correspondence Address: CATERPILLAR INC.;100 N.E. ADAMS STREET, PATENT DEPT., PEORIA, IL, 616296490, US

(21) Appl. No.: 11/236,172

(22) Filed: Sep. 27, 2005

Related U.S. Application Data
(63) Continuation-in-part of application No. 10/423,586, filed on Apr. 25, 2003.

(51) Int. Cl. F16H 37/00

(52) U.S. Cl. 74/15.6

(57) ABSTRACT

A power takeoff assembly having a brake assembly operable to prevent undesirable rotation of a power takeoff shaft when the power takeoff shaft is in a disengaged state. A clutch assembly is placed in an engaged state when pressurized fluid from a pressure source causes a first clutch element to engage a second clutch element such that the input shaft drives the power takeoff shaft. The clutch assembly is placed in a disengaged state when pressurized fluid from the pressure source is removed from the clutch assembly. The brake engages an output of the input shaft when the clutch assembly is in the disengaged state to prevent fluid forces within the clutch assembly from driving the power takeoff shaft.

This application is a continuation-in-part of co-pending application Ser. No. 10/423,586 filed Apr. 25, 2003.

### TECHNICAL FIELD

The present invention generally relates to implement control and more specifically to a power takeoff assembly from a transmission.

### BACKGROUND

Many work machines, in particular agricultural work machines, have the capability to operate implements which are towed behind the work machine. Of these implements, certain types require power to perform an implement function. This power is generally provided by the work machine via a power takeoff assembly. Typically, power from the transmission is provided to the power takeoff assembly via an input shaft. A clutch is used to engage the input shaft to a power takeoff shaft which is then used to drive the implements.

It is desirable that the power takeoff shaft not rotate when the clutch disconnects the input shaft from the power takeoff shaft. This allows the operator to easily attach and detach the implements to the work machine. A drawback to using a fluid filled clutch is that if the input shaft is turning, viscous forces within the clutch can cause the power takeoff shaft to rotate at a slow speed. Stopping the engine, which takes time, and adversely affects the productivity of the operator, can solve this problem. A locking mechanism could be used to prevent rotation of the power takeoff shaft. A drawback to using the locking mechanism is that it is often desirable that the operator be able to manually turn the power takeoff shaft in order to facilitate the attachment and detachment of implements to the power takeoff shaft.

What is needed, therefore, is a method and apparatus for providing a power takeoff to the work machine.

### SUMMARY OF THE INVENTION

In accordance with a first aspect of the present invention, there is provided a power takeoff assembly having a housing, an input shaft configured to output to a power takeoff shaft, a clutch assembly configured to connect power between the input shaft and the power takeoff shaft, and a brake connected to the housing and operable to engage an output of the input shaft with the housing to prevent viscous forces within the clutch assembly from driving the power takeoff shaft.

In accordance with a second aspect of the present invention, there is provided a method of operating a power takeoff assembly. The method of operating the power takeoff assembly, having a housing, an input shaft configured to output to a power takeoff shaft, a clutch assembly configured to connect power between the input shaft and the power takeoff shaft, and a brake connected to the housing, includes the steps of placing the clutch assembly in an engaged state by applying a first clutch element to engage a second clutch element such that the input shaft drives the power takeoff shaft, placing the clutch assembly in a disengaged state and engaging an output of the input shaft with the housing to prevent viscous forces within the clutch assembly from driving the power takeoff shaft in response to placing the clutch assembly in the disengaged state.

### BRIEF DESCRIPTION OF THE DRAWING

FIG. 1 is cross-sectional view of a power takeoff assembly.

### DETAILED DESCRIPTION

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims.

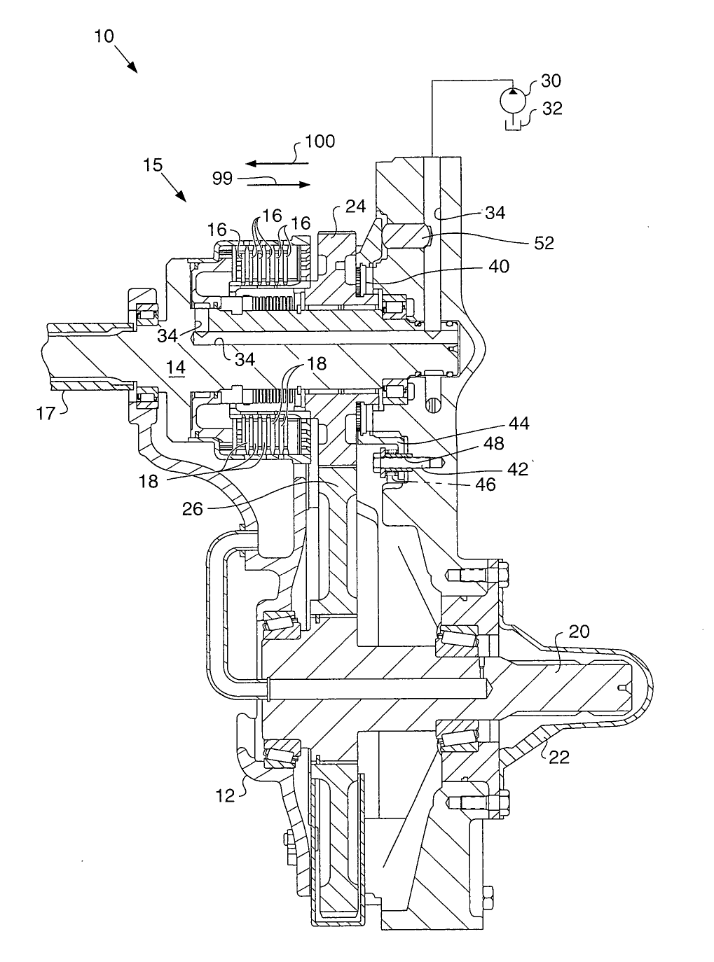

Referring now to FIG. 1, there is shown a power takeoff assembly 10 that incorporates the features of the present invention therein. The power takeoff assembly 10 includes a housing 12, which encases various components within the power takeoff assembly 10. The power takeoff assembly 10 further comprises an input shaft 14 driven by a transmission (not shown) through a drive member 17, which is in a spline relationship with the input shaft 14. The transmission may be driven by an engine (not shown) as part of a work machine (not shown), as is customary. The power takeoff assembly 10 further includes a power takeoff shaft 20. The power takeoff shaft 20 has a splined connection adapted to fit standard implements, which may be driven by the power takeoff shaft 20. A cover 22 may be removably mounted to the housing 12 to protect the shaft 20 when the shaft is not being used.

The power takeoff assembly 10 further includes a clutch assembly 15. The clutch assembly 15 includes a plurality of plates or first clutch elements 18 which are operatively connected to the input shaft 14 such that rotation of the input shaft 14 causes the first clutch elements 18 to rotate. The clutch assembly 15 further includes a plurality of disks or second clutch elements 16, which are splined to a first gear 24 and, in turn, the first gear 24 intermeshes an output or second gear 26. With the clutch assembly 15 engaged, rotation of the input shaft 14 causes concomitant rotation of the gear 24 through the engaged first and second clutch elements 18, 16. As a result, the power takeoff shaft 20 rotates as the first gear 24 drives the second gear 26, which is attached to the power takeoff shaft 20. Bearings 27 support the first gear 24 on the input shaft 14 and operate to allow the input shaft 14 to rotate without significantly rotating the first gear 24. It is noted, however, that the first gear 24 may rotate slightly due to frictional forces in the bearings 27.

The power takeoff assembly 10 further includes a source of pressurized fluid or pump 30, which draws hydraulic fluid from a sump 32 and advances the hydraulic fluid under pressure to a fluid conduit 34. When fluid flow from the pump 30 advances through the fluid conduit 34 to the clutch assembly 15, the first clutch elements 18 become engaged to the second clutch elements 16 thereby causing the input shaft 14 to drive the power takeoff shaft 20 and place the clutch assembly 15 in an engaged state. When fluid is removed from the clutch assembly 15, the first clutch elements 18 disengage from the second clutch elements 16 thereby preventing the input shaft 14 from driving the power takeoff shaft 20 and placing the clutch assembly 15 in a disengaged state.

The power takeoff assembly 10 further includes a brake assembly 40 operable to prevent undesirable rotation of the power takeoff shaft 20. The brake assembly 40 includes a brake disc 28, a plurality of fasteners (e.g. bolts) 42, and an actuator 44. The brake disc 28 is connected to the first gear 14 via a spline relationship, for example. The bolts 42 are secured to the housing 12 through the actuator 44 such that the actuator 44 is able to move in the general directions of arrows 99 and 100. A spring 46 is positioned between each bolt 42 and a sleeve 48 secured to the actuator 44. The springs 46 provide a bias force against the actuator 44 in the general direction of arrow 99 which biases the actuator 44 toward the brake disk 28, causing a force against the brake disk 28, between the actuator 44 and the housing 12. The actuator 44 may also include a friction type element, such as a brake pad, or clutch pad, as is known in the art, which contacts the brake disk 28.

The braking force acting on the brake disk 28 is sufficient to overcome any rotating force caused in the clutch assembly 15 by the first clutch elements 18 acting on the second clutch elements 16 through viscous forces transferred via the hydraulic fluid in the clutch assembly 15. Thus, when the clutch assembly 15 is disengaged, the brake assembly 40 prevents the brake disk 28 and the first gear 14 from rotating, and therefore, the power takeoff shaft 20 is prevented from rotating.

On the other hand, it is desirable that the operator of the work machine be able to manually rotate the power takeoff shaft 20. As a result, in an exemplary embodiment, the biasing force provided by the springs 46 acting on the actuator 44 is calibrated to prevent the viscous force within the clutch assembly 15 from overcoming the braking force acting on the brake disk 28. In so doing, the power takeoff shaft 20 is prevented from undesirable rotation due to the significant viscous force, however, the power takeoff shaft 20 may be manually rotated by the operator, if necessary.

A piston 52 operates to move the actuator 44 out of contact with the brake disk 28 in the general direction of arrow 100. The piston 52 is positioned in fluid communication with the fluid conduit 34 such that pressurized fluid in the conduit 34 moves the piston 52 in the general direction of arrow 100 into contact with the actuator 44 and out of contact with the brake disk 28. Fluid at a first pressure, supplied to the fluid conduit 34, moves the actuator 44 out of contact with the brake disk 28, whereas fluid at a second pressure supplied to the fluid conduit 34 causes the first clutch elements 18 to engage the second clutch elements 16 thereby placing the clutch assembly in the engaged state. It should be appreciated that the first pressure is less than the second pressure such that the actuator 44 is moved out of contact with the brake disk 28 prior to the clutch assembly 15 being placed in the engaged state.

### INDUSTRIAL APPLICABILITY

In operation, when the clutch assembly 15 is placed in the disengaged state, rotation of the input shaft 14 does not cause rotation of the power output shaft 20. To prevent the viscous forces within the clutch assembly 15 from rotating the power takeoff shaft 20, the brake assembly 40 presses the brake disk 28 against the housing 12. The springs 46 bias the actuator 44 toward the housing 12, which urges the brake disk 28 against the housing 12 with sufficient braking force to overcome any rotation caused by viscous forces within the clutch assembly 15. In addition, the springs 46 are calibrated such as to allow an operator to manually rotate the power takeoff shaft 20 should that be necessary.

To place the clutch assembly 15 in the engaged state, pressurized fluid is selectively supplied to the fluid conduit 34 via the pump 30. When the pressurized fluid reaches a first pressure, the fluid acts on the piston 52, which forces the actuator 44 out of contact with the brake disk 28, in the general direction of arrow 100. When the pressurized fluid in the conduit 34 reaches a second pressure, the pressurized fluid in the clutch assembly 15 begins to urge the first clutch elements 18 into contact with the second clutch elements 16 thereby placing the clutch assembly 15 in the engaged state. Placing the clutch assembly 15 in the engaged state causes rotation of the input shaft 14 to rotate the power takeoff shaft 20. It should be appreciated that the first pressure is less than the second pressure so as to move the brake 40 out of contact with the housing 12 prior to placing the clutch assembly 15 in the engaged state.

It will be apparent to those skilled in the art that various modifications and variations can be made in the disclosed power takeoff assembly without departing from the scope or spirit of the invention. Other embodiments of the invention will be apparent to those skilled in the art from consideration of the specification and practice of the invention disclosed herein. It is intended that the specification and examples be considered as exemplary only.

Other aspects, objects and advantages of the present invention can be obtained from a study of the drawings, the disclosure and the appended claims.

What is claimed is:

1. A power takeoff assembly having:
a housing;
an input shaft configured to output to a power takeoff shaft;
a clutch assembly configured to connect power between the input shaft and the power takeoff shaft; and
a brake connected to the housing and operable to engage an output of the input shaft with the housing to prevent viscous forces within the clutch assembly from driving the power takeoff shaft.

2. The assembly of claim 1, wherein the brake is calibrated such that the viscous force within the clutch assembly will not overcome a braking force between the brake, the output of the input shaft, and the housing, and cause the power takeoff shaft to rotate, and the power takeoff shaft can be manually rotated if necessary.

3. The assembly of claim 1, further comprising at least one spring configured to bias the brake toward the housing.

4. The assembly of claim 1, further comprising a release mechanism having a piston and in contact with the brake, wherein upon actuation of the release mechanism, the power takeoff shaft is free to rotate.

5. The assembly of claim 4, further comprising:
a source of pressurized fluid; and
a fluid conduit configured to provide fluid from the source of pressurized fluid to the clutch assembly,
wherein, supplying pressurized fluid via the fluid conduit places the clutch assembly in the engaged state and applies pressure against the piston to disengage the brake.

6. The assembly of claim 5, wherein fluid at a first pressure disengages the brake and fluid at a second pressure places the clutch assembly in the engaged state.

7. The assembly of claim 6, wherein the first pressure is less than the second pressure such that the brake disengages before the clutch assembly engages.

8. The assembly of claim 1, wherein the input shaft outputs through the clutch assembly to a first gear, which intermeshes a second gear attached to the power takeoff shaft, and wherein a brake disk is attached to the first gear.

9. The assembly of claim 8, wherein the brake presses the brake disk against the housing to prevent the power takeoff shaft from rotating.

10. A method of operating a power takeoff assembly having a housing, an input shaft configured to output to a power takeoff shaft, a clutch assembly configured to connect power between the input shaft and the power takeoff shaft, and a brake connected to the housing, comprising the steps of:
placing the clutch assembly in an engaged state by applying a first clutch element to engage a second clutch element such that the input shaft drives the power takeoff shaft;
placing the clutch assembly in a disengaged state; and
engaging an output of the input shaft with the housing to prevent viscous forces within the clutch assembly from driving the power takeoff shaft in response to placing the clutch assembly in the disengaged state.

11. The method of claim 10, further comprising the step of calibrating the brake such that a viscous force within the clutch assembly is less than a braking force resulting from the brake.

12. The method of claim 10, further comprising the step of biasing the brake toward the housing to prevent rotation of the power takeoff shaft.

13. The method of claim 12, further comprising the step of moving the brake out of contact with the housing with a piston.

14. The method of claim 13, further comprising the step of simultaneously supplying pressurized fluid to engage the clutch assembly and applying pressure against the piston to move the brake out of contact with the housing.

15. The method of claim 14, further comprising the steps of:
supplying fluid at a first pressure to move the brake out of contact with the housing; and
supplying fluid at a second pressure to place the clutch assembly in the engaged state wherein the first pressure is less than the second pressure.
